(19) United States
(12) Patent Application Publication
(10) Pub. No.: US 2026/0126637 A1
(43) Pub. Date: May 7, 2026

(54) HOUSINGS FOR CENTRIFUGE FORCE MICROSCOPE SYSTEMS, AND CENTRIFUGES USING SAME

(71) Applicant: The Research Foundation for the State University of New York, Albany, NY (US)

(72) Inventor: Kenneth Halvorsen, Albany, NY (US)

(21) Appl. No.: 19/383,334

(22) Filed: Nov. 7, 2025

Related U.S. Application Data
(60) Provisional application No. 63/717,630, filed on Nov. 7, 2024.

(51) Int. Cl. G02B 21/24; G01N 15/1434; G02B 21/00; G02B 21/06

(52) U.S. Cl. CPC G02B 21/24; G01N 15/1436; G02B 21/0004; G02B 21/06

(57) ABSTRACT

A housing for a centrifuge force microscope system is disclosed. The housing includes a first component including a bottom portion including an internal surface, an illumination housing formed on the internal surface, and a mirror mount formed on the internal surface, adjacent the illumination housing. The first component also includes a plurality of support pillars extending perpendicular to the internal surface. The housing also includes a second component releasably coupled to the first component. The second component includes a top portion formed opposite the bottom portion of the first component. The top portion includes a plurality of openings formed therethrough. The second component also includes a sidewall extending perpendicular to the top portion, where the sidewall is configured to contact the plurality of support pillars of the first component.

### CROSS-REFERENCE TO RELATED APPLICATION

This application claims the benefit of U.S. Provisional Patent Application No. 63/717,630, filed Nov. 7, 2024, the entirety of which is hereby incorporated herein by this reference.

### GOVERNMENT RIGHTS

This invention was made with government support under Grant No. GM124720 awarded by the National Institute of Health. The government has certain rights in the invention.

### BACKGROUND

The disclosure relates generally to housings for microscope systems, and more particularly, to housings for centrifuge force microscope systems, and centrifuges using the housings, centrifuge force microscope systems, and balancing devices.

A Centrifuge Force Microscope (CFM) is a specialized instrument that combines the principles of optical microscopy and centrifugation to study molecular and cellular interactions under precisely controlled mechanical forces. In a CFM, microscopic samples—such as biomolecules, cells, or microbeads—are mounted on a rotating platform that subjects them to centrifugal forces while being observed in real time with an optical microscope. This allows researchers to investigate how biological structures respond to mechanical stress, measure binding forces between molecules, and study the dynamics of mechanical unfolding or deformation at the microscopic level. CFMs are particularly valuable in biophysics and molecular biology, where understanding force-dependent behavior is crucial.

However, one of the key challenges in CFMs lies in the design and construction of their housings, which must protect sensitive optical and electronic components while allowing high-speed rotation. Because the system involves both precise optical alignment and substantial rotational motion, the housing needs to be robust enough to withstand large centrifugal forces without deforming or vibrating. Many early or laboratory-built CFMs relied on heavy and bulky housings to ensure mechanical stability and safety, often using metal or reinforced composite materials. While this approach ensures structural integrity, it also introduces several operational drawbacks.

Issues with heavy and bulky housings become apparent during operation. Excessive mass increases the mechanical load on the centrifuge motor, limiting achievable rotational speeds and reducing experimental flexibility. It can also make balancing more difficult, leading to vibrations, mechanical wear, and potential safety risks at high speeds. Moreover, large housings hinder accessibility for sample mounting, maintenance, and optical adjustments, making the setup cumbersome and time-consuming to use. These issues can reduce experimental throughput and precision.

### BRIEF DESCRIPTION

A first aspect of the disclosure provides housing for a centrifuge force microscope system. The housing includes: a first component including: a bottom portion including an internal surface, an illumination housing formed on the internal surface, a mirror mount formed on the internal surface, adjacent the illumination housing, and a plurality of support pillars extending perpendicular to the internal surface; and a second component releasably coupled to the first component, the second component including: a top portion formed opposite the bottom portion of the first component, the top portion including a plurality of openings formed therethrough, and at least one sidewall extending perpendicular to the top portion, the at least one sidewall configured to contact the plurality of support pillars of the first component.

A second aspect of the disclosure provides a centrifuge force microscope system, including: a housing configured to be positioned within a centrifuge sample bucket, the housing including: a first component including: a bottom portion including an internal surface, an illumination housing formed on the internal surface, a mirror mount formed on the internal surface, adjacent the illumination housing, and a plurality of support pillars extending perpendicular to the internal surface; and a second component releasably coupled to the first component, the second component including: a top portion formed opposite the bottom portion of the first component, the top portion including a plurality of openings formed therethrough, and at least one sidewall extending perpendicular to the top portion, the at least one sidewall configured to contact the plurality of support pillars of the first component; a light element assembly positioned within the illumination housing formed on the internal surface of the first component for the housing; and a microscope assembly positioned within the housing, the microscope assembly including: an imaging subassembly affixed to at least one of the plurality of openings formed in the top portion of the second component and at least partially positioned between the bottom portion of the first component and the top portion of the second component; and a sample subassembly coupled to the imaging subassembly, adjacent to the bottom portion of the first component.

A third aspect of the disclosure provides a centrifuge, including: a spindle coupled to a rotor; a plurality of buckets coupled to the spindle, the plurality of buckets including a sample bucket and a balancing bucket positioned opposite the sample bucket; and a centrifuge force microscope system configured to be positioned within the sample bucket of the plurality of buckets, the centrifuge force microscope system includes: a housing including: a first component including: a bottom portion including an internal surface, an illumination housing formed on the internal surface, a mirror mount formed on the internal surface, adjacent the illumination housing, and a plurality of support pillars extending perpendicular to the internal surface; and a second component releasably coupled to the first component, the second component including: a top portion formed opposite the bottom portion of the first component, the top portion including a plurality of openings formed therethrough, and at least one sidewall extending perpendicular to the top portion, the at least one sidewall configured to contact the plurality of support pillars of the first component; a light element assembly positioned within the illumination housing formed on the internal surface of the first component for the housing; and a microscope assembly positioned within the housing, the microscope assembly including: an imaging subassembly affixed to at least one of the plurality of openings formed in the top portion of the second component and at least partially positioned between the bottom portion of the first component and the top portion of the second component; and a sample subassembly coupled to the imaging subassembly, adjacent to the bottom portion of the first component.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a top view of a centrifuge including a centrifuge force microscope system including a housing, and a balancing device, according to embodiments of the disclosure.

FIG. 2A shows a perspective view of a housing included in a centrifuge force microscope system, according to embodiments of the disclosure.

FIG. 2B shows a side, exploded view of the housing of FIG. 2A, according to embodiments of the disclosure.

FIG. 3A shows a perspective view of a first component of the housing of FIG. 2A, according to embodiments of the disclosure.

FIG. 3B shows a top view of the first component of FIG. 3A, according to embodiments of the disclosure.

FIG. 4A shows a perspective view of a second component of the housing of FIG. 2A, according to embodiments of the disclosure.

FIG. 4B shows a front view of the second component of FIG. 4A, according to embodiments of the disclosure.

FIG. 4C shows a top view of the second component of FIG. 4A, according to embodiments of the disclosure.

FIG. 4D shows a bottom view of the second component of FIG. 4A, according to embodiments of the disclosure.

FIG. 5A shows a perspective view of a third component of the housing of FIG. 2A, according to embodiments of the disclosure.

FIG. 5B shows a top view of the third component of FIG. 5A, according to embodiments of the disclosure.

FIG. 5C shows a bottom view of the third component of FIG. 5A, according to embodiments of the disclosure.

FIG. 6A shows a partially exploded view of a centrifuge force microscope system including a housing, according to embodiments of the disclosure.

FIG. 6B shows a cross-sectional front view of the centrifuge force microscope system and the housing taken along line 6B-6B in FIG. 6A, according to embodiments of the disclosure.

FIG. 7 shows a perspective view of a housing for a centrifuge force microscope system, according to additional embodiments of the disclosure.

FIG. 8A shows an exploded perspective view of a balancing device used within a centrifuge, according to embodiments of the disclosure.

FIG. 8B shows a side view of the balancing device of FIG. 8A, according to embodiments of the disclosure.

FIG. 8C shows a top view of the balancing device of FIG. 8A, according to embodiments of the disclosure.

FIG. 8D shows a cross-sectional side view of the balancing device taken along line 8D-8D in FIG. 8B, according to embodiments of the disclosure.

FIG. 9 shows a perspective view of a balancing device used within a centrifuge, according to further embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

As an initial matter, in order to clearly describe the current disclosure it will become necessary to select certain terminology when referring to and describing relevant components within the disclosure. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

As discussed herein, the disclosure relates generally to housings for microscope systems, and more particularly, to housings for centrifuge force microscope systems, and centrifuges using the housings, centrifuge force microscope systems, and balancing devices.

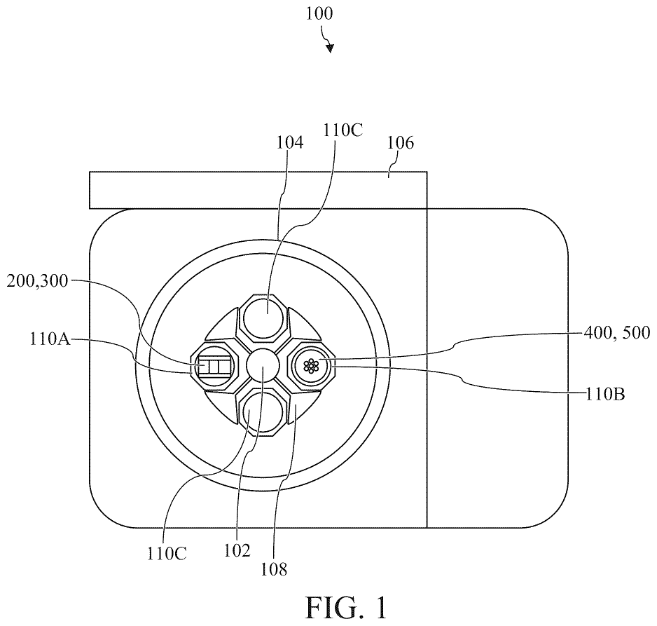

These and other embodiments are discussed below with reference to FIGS. 1-9. However, those skilled in the art will readily appreciate that the detailed description given herein with respect to these Figures is for explanatory purposes only and should not be construed as limiting.

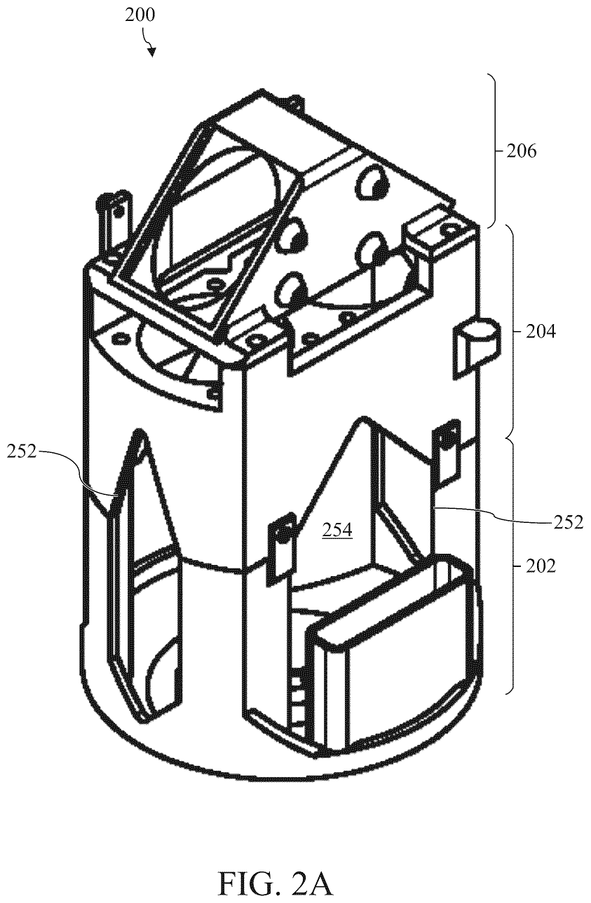

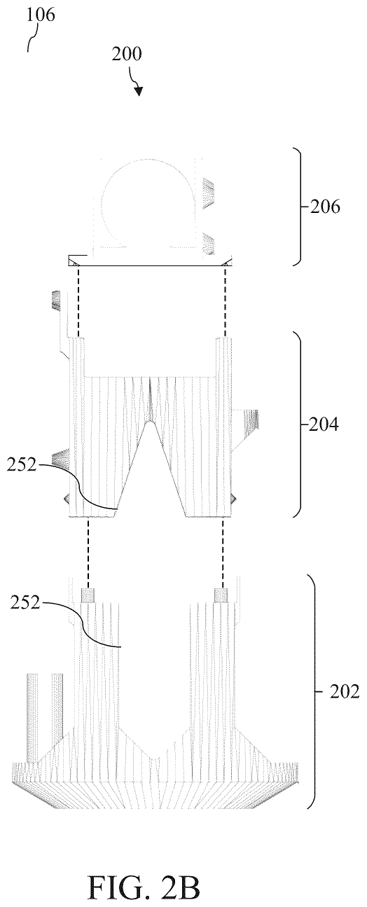

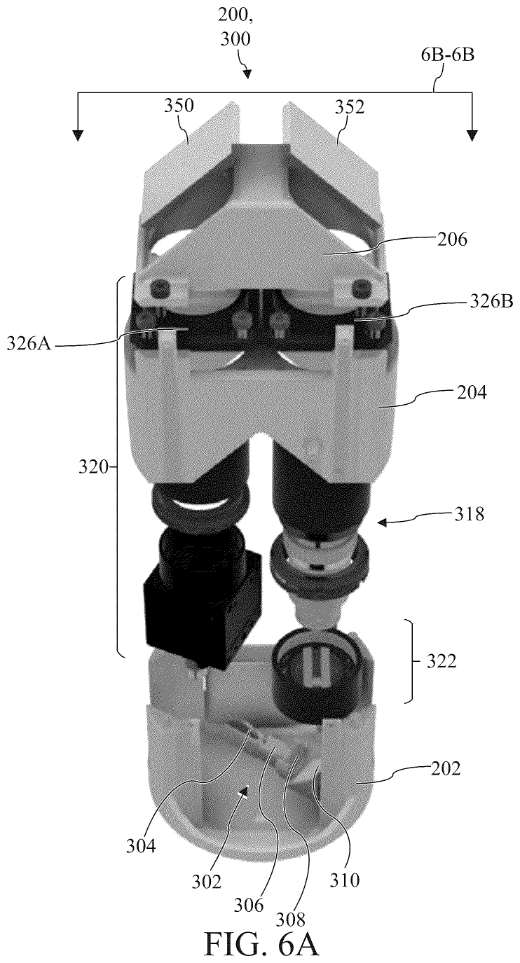

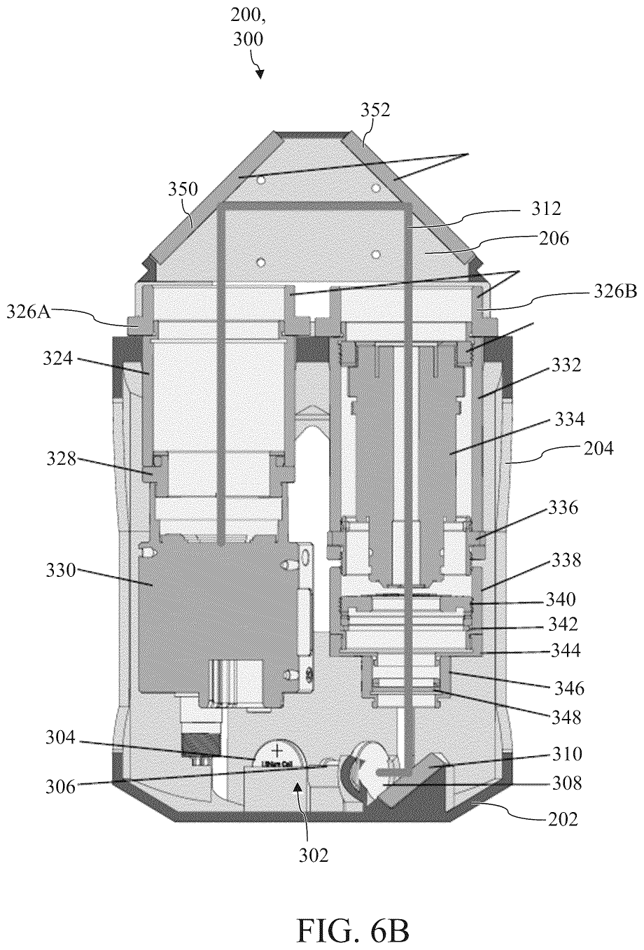

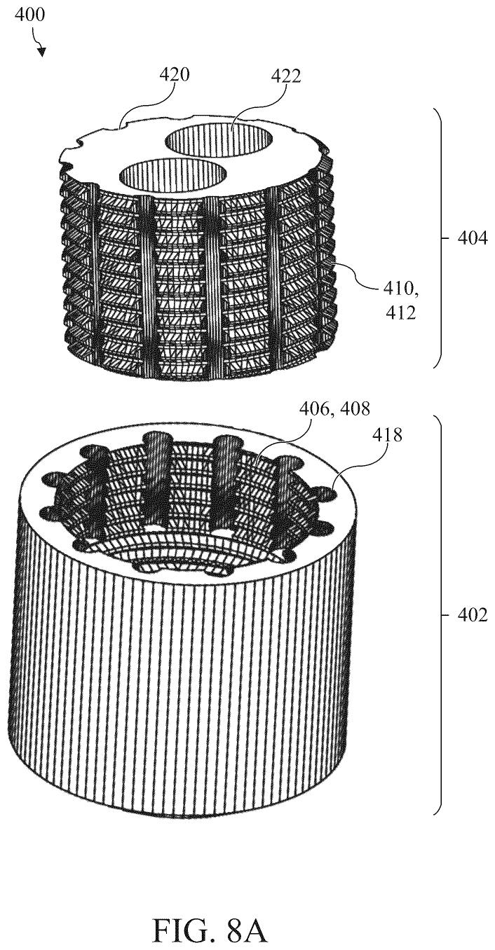

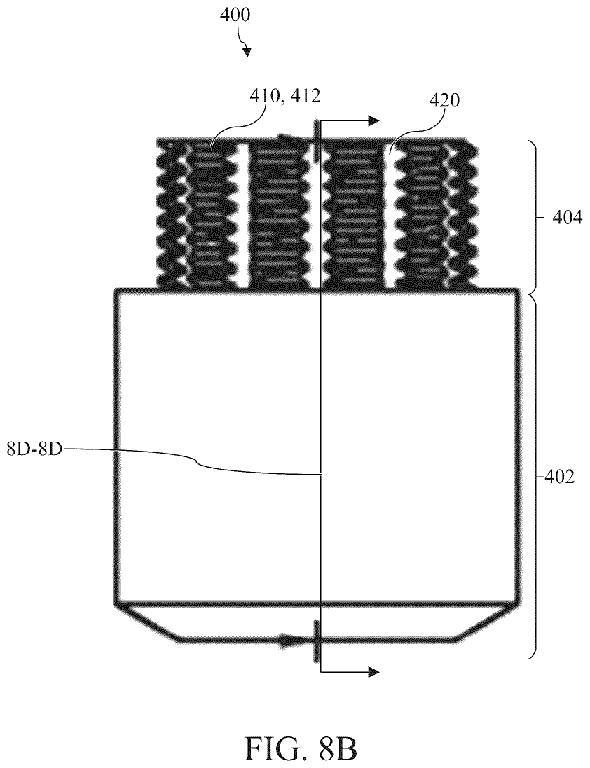

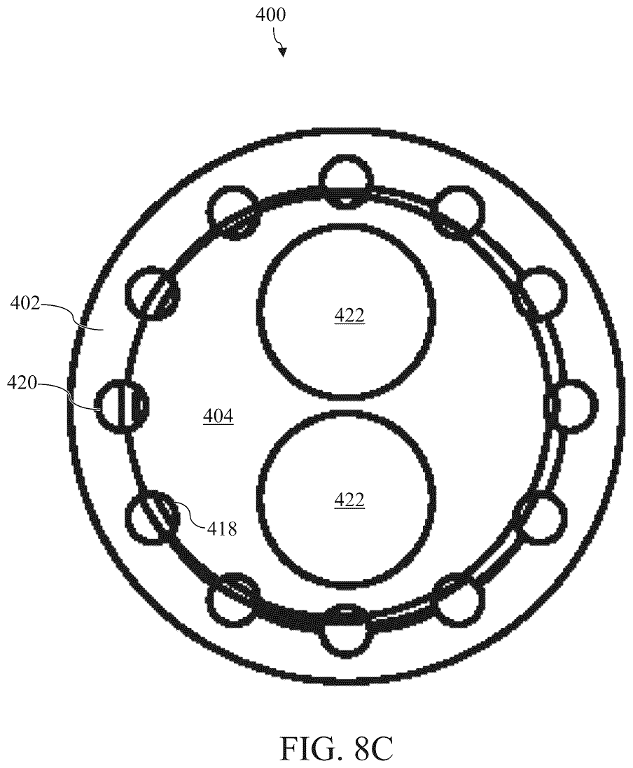

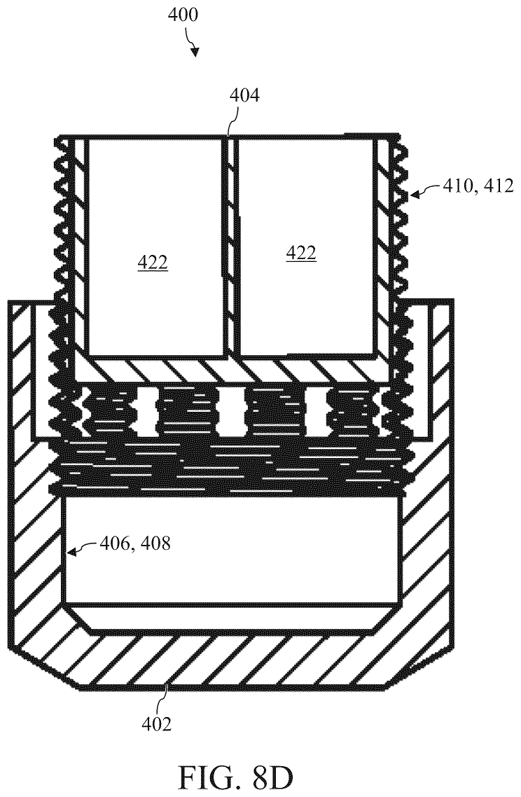

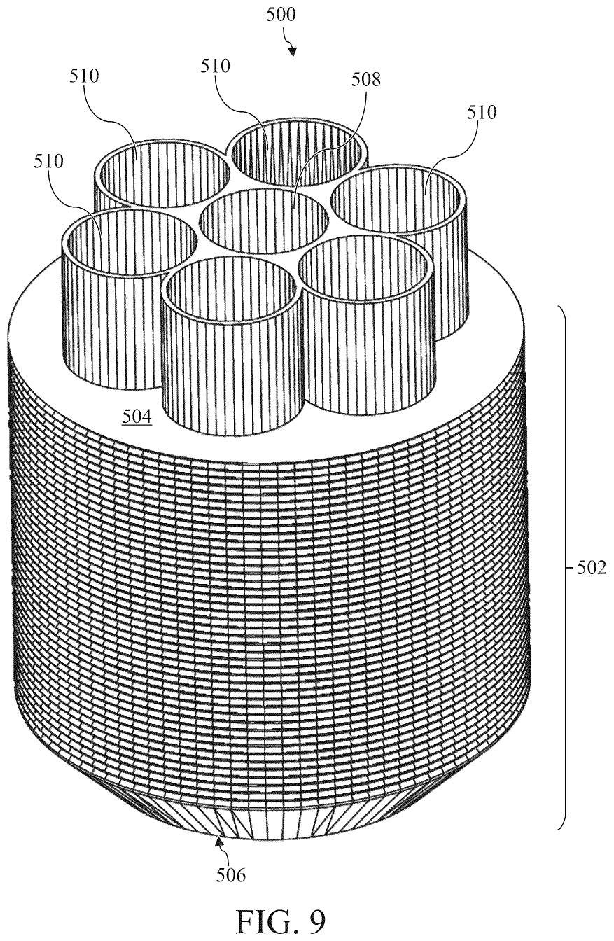

FIG. 1 shows a top view of a centrifuge 100 configured to utilize a housing 200 (see, FIGS. 2A and 2B) included in a centrifuge force microscope system 300 (see, FIGS. 6A and 6B), and balancing device(s) 400, 500 (see, FIGS. 8A-9). Centrifuge 100, as shown in FIG. 1, is formed as a suitable benchtop centrifuge configured of spinning and/or applying a centrifugal force to a sample disposed therein during operation. In the exemplary embodiment shown, centrifuge 100 includes a spindle 102 formed within a testing chamber 104 and coupled to a rotor (not shown) of centrifuge 100. Spindle 102 is configured to rotate within testing chamber 104 during operation of centrifuge 100. Centrifuge 100 also includes a lid 106 configured to be positioned over and/or substantially seal testing chamber 104 during operation. A support frame 108 is coupled to, extends from, and/or substantially surrounds spindle 102. Additionally as shown in FIG. 1, a plurality of buckets 110 are coupled to rotor via spindle 102 and/or support frame 108, such that during operation of centrifuge 100, spindle 102, support frame 108, and each of the plurality of buckets 110 rotate together within testing chamber 104.

In the exemplary embodiment, the plurality of buckets 110 includes four (4) distinct buckets. More specifically, the plurality of buckets 110 include (1) a sample bucket 110A, (2) a balancing bucket 110B positioned directly opposite and/or aligned with sample bucket 110A, and (3) two empty buckets 110C formed opposite one another and substantially between sample bucket 110A and balancing bucket 110B. As discussed herein, sample bucket 110A includes, receives, and/or holds housing 200 and/or centrifuge force microscope system 300 and a material sample (see, FIG. 6B) during operation. Additionally, balancing bucket 110B includes, receives, and/or holds balancing device(s) 400, 500 during operation of centrifuge 100, where balancing device 400, 500 includes a similar weight, center of mass, and/or weight distribution of housing 200 and/or centrifuge force microscope system 300 and the sample to maintain “balance” within centrifuge 100. In an exemplary embodiment, the two opposing empty buckets 110C remain empty during operation of centrifuge 100. However, in other exemplary embodiments, two empty buckets 110C may also include a distinct centrifuge force microscope system 300 including a distinct housing 200, and a distinct balancing device(s) 400, 500, respectively, such that centrifuge 100 can test and/or image multiple samples at a time. Additionally in exemplary embodiments (not shown), the features, structures, and/or configurations included in centrifuge force microscope system 300 can be disposed and/or positioned within both housing 200, as well as empty buckets 110C of centrifuge 100. Although four (4) buckets 110 are shown, it is understood that centrifuge 100 can include more or less buckets, so long as there is a substantially even weight distribution between opposing buckets within centrifuge 100 during operation, as discussed herein.

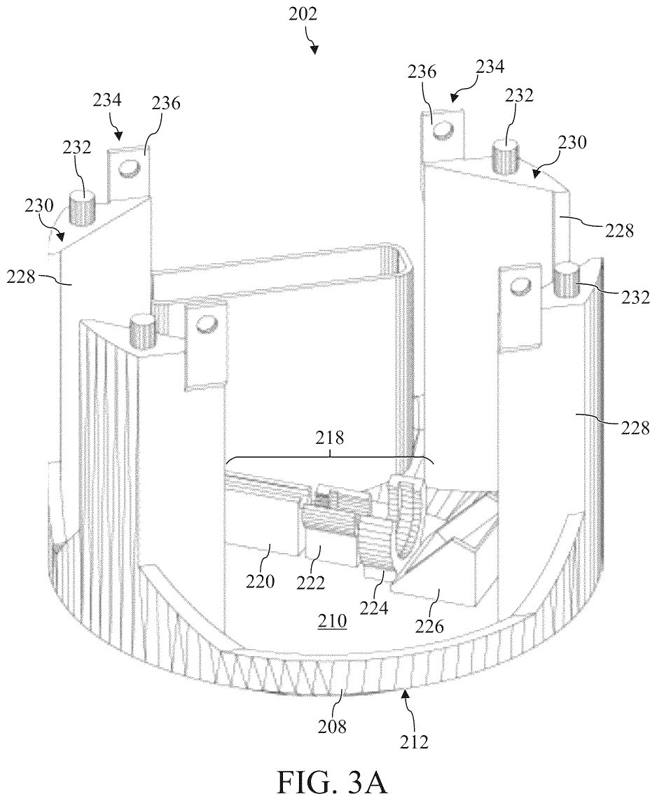

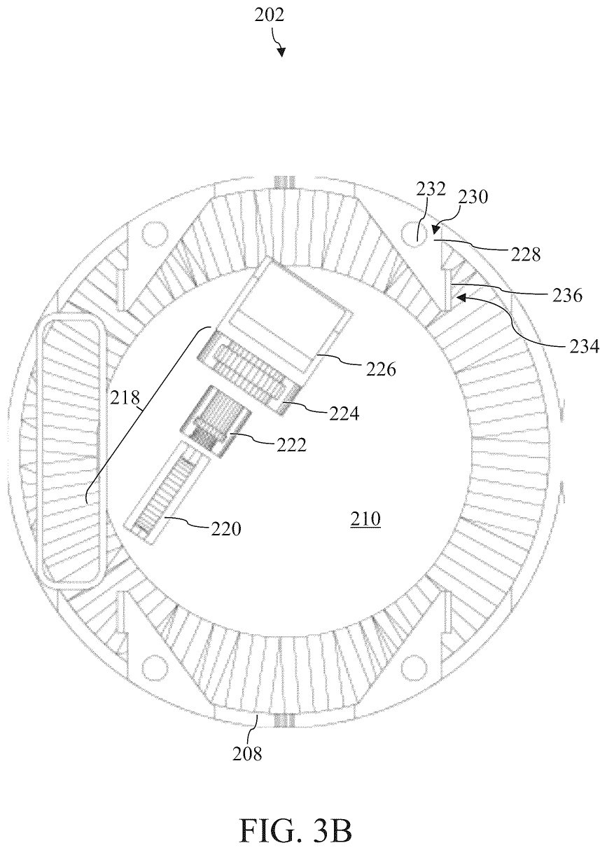

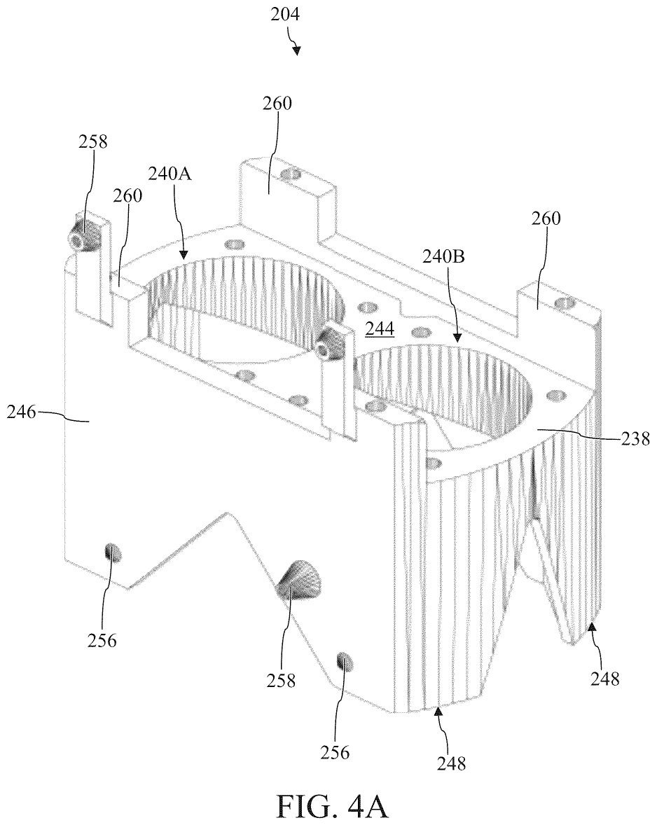

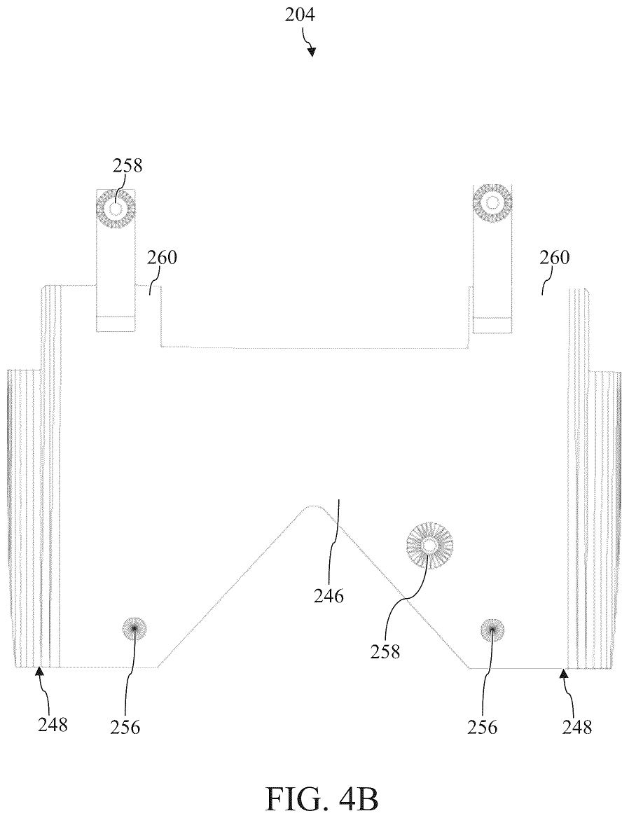

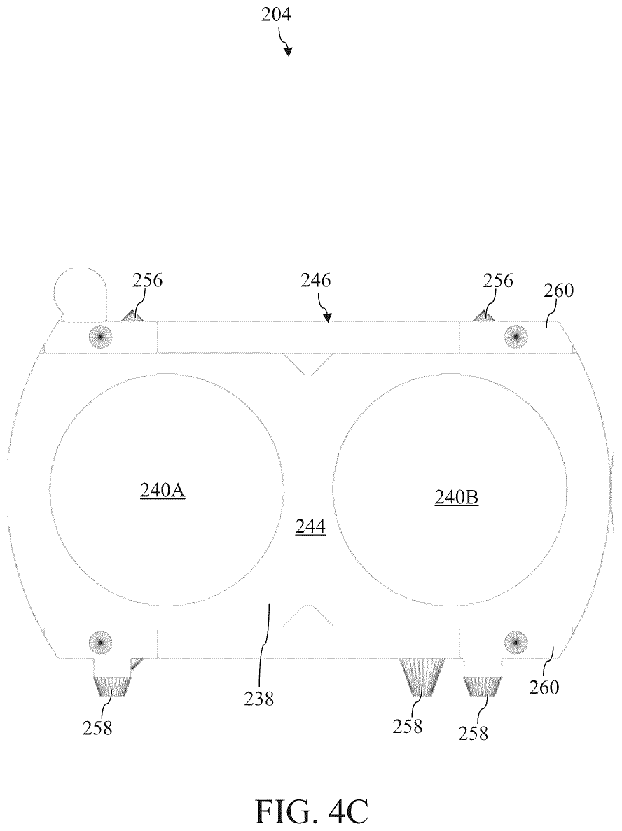

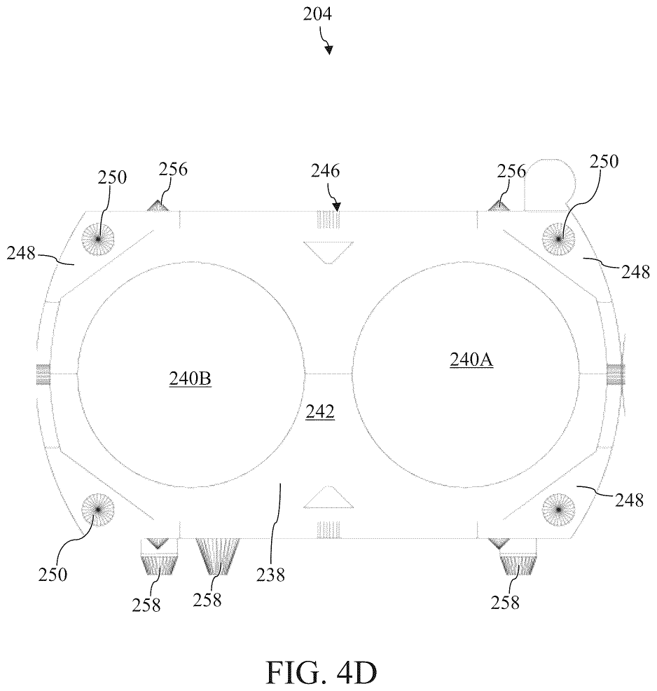

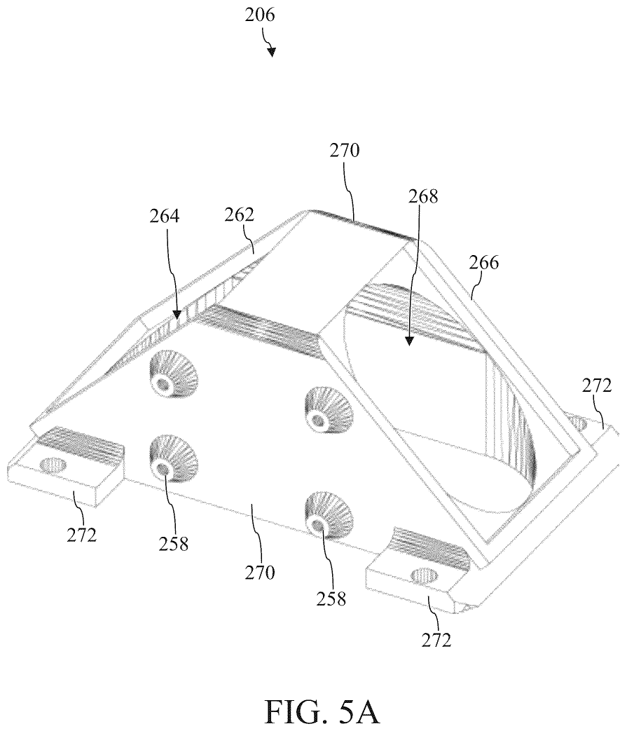

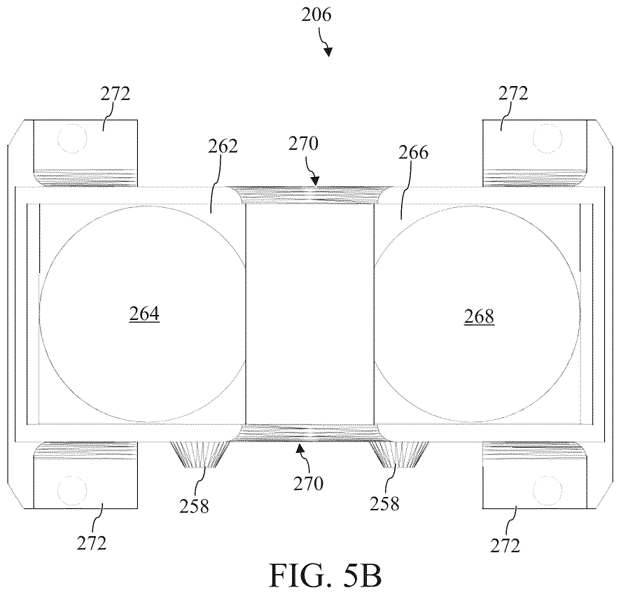

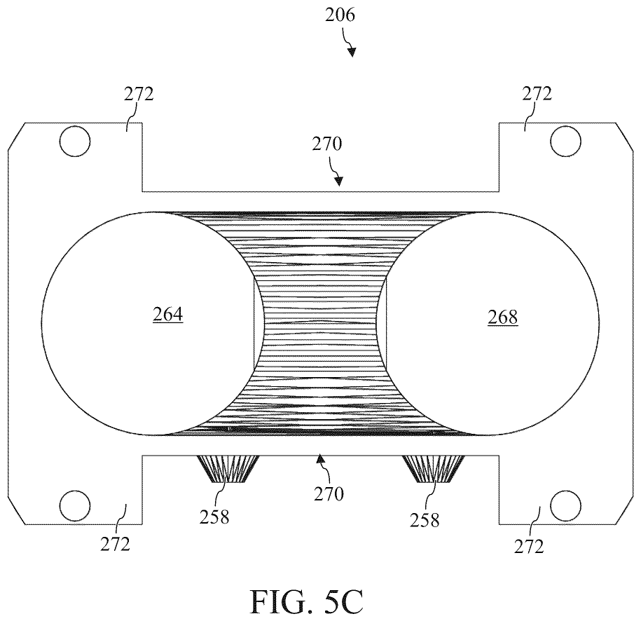

FIGS. 2A-5C show various views of housing 200 used within centrifuge 100, and the various components forming housing 200. More specifically, FIG. 2A shows a perspective view of housing 200, while FIG. 2B shows an exploded, side view of housing 200. Moreover, FIGS. 3A and 3B show various views of a first component 202 of housing 200, FIGS. 4A-4D show various views of a second component 204 of housing 200, and FIGS. 5A-5C show various views of a third component 206 of housing 200. In the exemplary embodiments, and for the sake of clarity, housing 200 does not include any portion of a light element assembly and/or microscope assembly of centrifuge force microscope system 300 in FIGS. 2A-5C (see, FIGS. 6A and 6B).

As shown in FIGS. 2A and 2B, housing 200 is formed from first component 202, second component 204, and third component 206. In the exemplary embodiment, each of the respective components 202, 204, 206 forming housing 200 are configured to be releasably coupled to one another. More specifically, first component 202 and second component 204 are releasably coupled, and second component 204 and third component 206 are also configured to be releasably coupled to one another during operation and/or use within centrifuge 100 (see, FIG. 1). First component 202, second component 204, and third component 206 each include various features, portions, and/or configurations to facilitate the coupling between components to form housing 200, as discussed herein. Moreover, each component 202, 204, 206 of housing 200 is also configured to be released and/or removed from the remainder of the components forming housing 200, without uncoupling each component 202, 204, 206. For example, first component 202 is configured to be uncoupled from second component 204 without requiring third component 206 also being uncoupled from second component 204. As discussed herein, the ability to uncouple first component 202 from second component 204 provides improved access to test samples without disrupting and/or having to remove distinct portions of centrifuge force microscope system 300.

As discussed herein, each of first component 202, second component 204, and third component 206, and the various portions, features, and/or configurations included in each component, are formed integral and/or as a single unitary embodiment. That is, and in exemplary embodiments, first component 202, and the various features formed and/or included therein, are formed as a single, unitary embodiment or component, while second component 204 and its various features is also formed as a single, unitary embodiment or component, distinct from first component 202. In this non-limiting example, each of first component 202, second component 204, and third component 206 may be manufactured using additive manufacturing processes and/or techniques (e.g., 3D printing). Furthermore, each component 202, 204, 206, and the various features included therein for to form housing 200 and facilitate the support of portions of centrifuge force microscope system 300, can be formed within respective components 202, 204, 206 without the need of additional additive structural supports, overhangs, and/or sacrificial printing material. This in turn reduces post-printing “clean-up” and/or additional post processing before utilizing housing 200 within centrifuge 100. In other exemplary embodiments, components 202, 204, 206 forming housing 200 can be formed using any suitable manufacturing technique including milling, machining, casting, injection molding, and the like. Furthermore, components 202, 204, 206 forming housing 200 can be formed from any suitable material capable of supporting portions and/or assemblies of centrifuge force microscope system 300 during operation of centrifuge 100. For example, components 202, 204, 206 of housing 200 can be formed from materials including, but not limited to, polymers, metals, metal alloys, ceramics, fibrous materials (e.g., fiberglass), and the like.

FIG. 3A shows a perspective view of first component 202, and FIG. 3B shows a top view of first component 202. First component 202 of housing 200 includes a base or bottom portion 208 (hereafter, “bottom portion 208”) including an internal surface 210. Bottom portion 208 of first component 202 also includes an external surface 212 formed opposite internal surface 210. During operation external surface 212 of bottom portion 208 contacts and/or rests upon an inner surface of sample bucket 110A. Internal surface 210 of bottom portion 208 for first component 202 includes an illumination housing 218 formed thereon. More specifically, and as shown in FIGS. 3A and 3B, illumination housing 218 is formed directly on, integral with, and/or directly over at least a portion of internal surface 210 of bottom portion 208. Illumination housing 218 is formed within first component 202 to support, receive, and/or hold various components of a light element assembly (see, FIGS. 6A and 6B) included in centrifuge force microscope system 300. For example, and as shown in FIGS. 3A and 3B, illumination housing 218 includes a battery slot 220 configured to receive a battery of the light element assembly, a light element holder 222 configured to receive a lighting element (e.g., LED) of the light element assembly, and a diffuser mount 224 configured to receive a diffuser of the light element assembly. In the exemplary embodiments, light element holder 222 is positioned and/or formed on internal surface 210 of first component 202 between battery slot 220 and diffuser mount 224. Additionally as shown, a mirror mount 226 is also formed on internal surface 210 of bottom portion 208, adjacent to illumination housing 218. More specifically, mirror mount 226 is formed integrally on internal surface 210, directly adjacent to diffuser mount 224 of illumination housing 218, such that diffuser mount 224 is formed between light element holder 222 and mirror mount 226. As discussed herein, mirror mount 226 is configured to receive, hold, and/or fix a turning mirror adjacent illumination housing 218 and/or the light element assembly to be used by centrifuge force microscope system 300 during operation.

As shown in FIGS. 3A and 3B, first component 202 also includes a plurality of support pillars 228 extending from bottom portion 208. More specifically, the plurality of support pillars 228 extend from and/or adjacent to bottom portion 208, and substantially perpendicular to internal surface 210 of bottom portion 208, opposite external surface 212. When releasably coupled to second component 204, each of the plurality of support pillars 228 of first component 202 contact and/or abut a portion of second component 204. For example, a surface 230 for each support pillar 228 contacts and/or abuts second component 204 when first component 202 and second component 204 are releasably coupled to form housing 200. Four (4) support pillars 228 are formed within first component 202. However, it is understood that first component 202 can including more or less support pillars 228.

In the exemplary embodiments, first component 202 also includes a plurality of alignment guides 232 extending from the plurality of support pillars 228. That is, an alignment guide 232 extends from surface 230 of each of the plurality of support pillars 228 to aid in the alignment and coupling between first component 202 and second component 204 during operation. As discussed herein, second component 204 includes a plurality of recesses configured to receive alignment guides 232 formed in first component 202.

First component 202 of housing 200 also includes at least a portion of a releasable coupling feature 234 (hereafter, “coupling feature 234”) to facilitate the releasable coupling between first component 202 and second component 204. Additionally, and as discussed herein, second component 204 of housing 200 also includes a portion of coupling feature 234. Coupling feature 234 is formed from any suitable feature, configuration, and/or structure that is capable of releasably coupling first component 202 to second component 204. In the exemplary embodiments shown in FIGS. 3A and 3B, coupling feature 234 includes a closure-snap configuration where first component 202 includes a closure plate 236 (e.g., first portion of coupling feature 234) extending from each of the plurality of support pillars 228 included therein. Closure plate 236 of coupling feature 234 included in first component 202 includes a hole configured to engage a snap or protrusion (e.g., second or mating portion of coupling feature 234) included on second component 204 (see, FIGS. 4A-4D). Although discussed herein as a closure-snap configuration, it is understood that coupling feature 234 can be formed as any suitable feature, configuration, and/or structure that facilitates the releasable coupling between first component 202 and second component 204. For example, coupling feature 234 for first component 202 and second component 204 can be formed as a mechanical coupling or fastening feature (e.g., latch, pin, screws), a magnetic coupling feature, or the like.

FIG. 4A shows a perspective view of second component 204, FIG. 4B shows a side view of second component 204, FIG. 4C shows a top view of second component 204, and FIG. 4D shows a bottom view of second component 204. Second component 204 includes a top portion 238 formed opposite bottom portion 208 of first component 202. That is, second component 204 positioned over and/or configured to be releasably coupled to first component 202 includes top portion 238 formed opposite to and/or substantially aligned with bottom portion 208 of first component 202. As shown in FIGS. 4A, 4C, and 4D, a plurality of openings 240A, 240B are formed through top portion 238. As discussed herein, the plurality of openings 240A, 240B formed through top portion 238 of second component 204 are configured to support and/or receive portions and/or assemblies of centrifuge force microscope system 300 positioned within housing 200 during operation. Top portion 238 of second component 204 includes a first surface 242 facing internal surface 210 of bottom portion 208, and a second surface 244 formed opposite first surface 242.

Second component 204 also includes at least one sidewall 246 extending from top portion 238. More specifically, sidewall 246 extends from top portion 238 and substantially perpendicular to first surface 242 of top portion 238 of second component 204. Sidewall(s) 246 of second component 204 are configured to contact the plurality of support pillars 228 of first component 202 when forming housing 200. A contact surface 248 of sidewall(s) 246 for second component 204 contacts and/or abuts surface 230 for each support pillar 228 of first component 202 when first component 202 and second component 204 are releasably coupled to one another. In exemplary embodiments shown in FIG. 4D, a plurality of recesses 250 are also formed at least partially through sidewall 246 and/or on contact surface 248 for receiving alignment guides 232 of first component 202. That is, when first component 202 and second component 204 are coupled together, alignment guides 232 extending from support pillars 228 of first component 202 are positioned within and/or received by a corresponding recess 250 formed in sidewall 246 of second component 204 to aid in aligning and coupling first component 202 and second component 204.

With continued reference to FIGS. 4A and 4B, and briefly returning to FIGS. 2A-3A, portions of first component 202 and second component 204 collectively define at least one aperture 252 in housing 200. That is, and as shown in the exemplary embodiment of FIG. 2A, the plurality of support pillars 228 of first component 202 and cut-outs formed in sidewall 246 of second component 204 are formed to be substantially aligned, such that when first component 202 and second component 204 are releasably coupled, the plurality of support pillars 228 and sidewall 246 define apertures 252 within housing 200. At least one aperture 252 formed between and/or defined by first component 202 and second component 204 provide access an internal area 254 formed between first component 202 and second component 204. For example, aperture 252 included in housing 200 provides access to portions and/or assemblies of centrifuge force microscope system 300, the sample, and/or the light element assembly, all included within internal area 254 of housing 200, without the need to uncouple first component 202 from second component 204. In the non-limiting example, internal area 254 includes an area within housing 200 between bottom portion 208 of first component 202 and top portion 238 of second component 204, as well as area or space defined by the plurality of support pillars 228 of first component 202 and sidewall 246 of second component 204, respectively. Furthermore, the formation of aperture 252 within housing 200 also reduces the weight and/or material requirement for housing 200.

Similar to first component 202, second component 204 of housing 200 also includes at least a portion of coupling feature 234 to facilitate the releasable coupling between first component 202 and second component 204. As discussed herein, coupling feature 234 includes a closure-snap configuration where first component 202 includes closure plate 236 (see, FIGS. 3A and 3B), and second component 204 includes a plurality of snaps or projections 256 (e.g., second or mating portion of coupling feature 234). In the exemplary embodiments shown in FIGS. 4A-4D, projections 256 are formed on and/or extend from an outer surface of sidewall 246. During coupling, each projection 256 formed and/or included on second component 204 is positioned in, secured within, and/or engages the opening formed through closure plate 236 included on first component 202 to releasably couple first component 202 and second component 204.

As shown in FIG. 4B, second component 204 also includes a plurality of electronics mounts 258 formed thereon. Electronics mounts are formed on and/or adjacent to sidewall 246 of second component 204 and are configured to facilitate the mounting of electronic portions of centrifuge force microscope system 300 to housing 200 during operation.

In exemplary embodiments, second component 204 further includes a plurality of coupling protrusions 260. Coupling protrusions 260 are formed on and/or extend from top portion 238 of second component 204. More specifically, protrusions 260 are formed integral with top portion 238, and extend from and/or substantially perpendicular to second surface 244 of top portion 238 for second component 204. Additionally as shown, coupling protrusions 260 also extend from top portion 238 opposite sidewall 246. As discussed herein, coupling protrusions 260 aid in the releasable coupling between second component 204 and third component 206.

FIG. 5A shows a perspective view of third component 206, FIG. 5B shows a top view of third component 206, and FIG. 5C shows a bottom view of third component 206. As discussed herein, third component 206 is releasably coupled to second component 204, opposite first component 202, when forming housing 200. Third component 206 includes a first angled wall 262 including an aperture 264. In exemplary embodiments, first angled wall 262 and/or aperture 264 are aligned with first opening 240A of the plurality of openings formed through top portion 238 of second component 204. Additionally, third component 206 also includes a second angled wall 266 formed adjacent first angled wall 262. Second angled wall Second angled wall 266 also includes an aperture 268 formed and/or extending therethrough. Second angled wall 266 and/or aperture 268 formed therethrough are aligned with second, distinct opening 240B of the plurality of openings formed through top portion 238 of second component 204. Additionally in exemplary embodiments, first angled wall 262 and second angled wall 266 are formed to include approximately a 45- and −45-degree angle, respectively, to redirect a light/view path approximately 90 degrees during operation, as discussed herein. Moreover, and as discussed herein, first angled wall 262 and second angled wall 266 are each configured to receive, mount, and/or secure a turning mirror within third component 206 to be utilized by assemblies of centrifuge force microscope system 300 during operation. As such, apertures 264, 268 formed in angled walls 262, 266 provide an unobstructed line of sight between assemblies of centrifuge force microscope system 300 and turning mirrors coupled within third component 206. Although shown and discussed herein as including apertures 264, 268, it is understood that angled walls 262, 266 can be solid (e.g., without apertures 264, 268) within housing 200. In this exemplary embodiment, turning mirrors utilized within centrifuge force microscope system 300 are mounted to an inside surface of angled walls 262, 266 to provide the unobstructed line of sight between assemblies of centrifuge force microscope system 300 and the mirrors.

Third component 206 also includes two barrier walls 270 formed opposite one another and extending between first angled wall 262 and second angled wall 266, respectively. Similar to second component 204, barrier walls 270 include a plurality of electronics mounts 258 formed thereon. As discussed herein, electronics mounts are formed on and/or adjacent to barrier walls 270 of third component 206 and are configured to facilitate the mounting of electronic portions of centrifuge force microscope system 300 to housing 200 during operation.

As shown in FIGS. 5A-5C, third component 206 also includes a plurality of coupling tabs 272 extending perpendicular to barrier walls 270. That is, a plurality of coupling tabs 272 extend perpendicularly from each of the two barrier walls 270, opposite a top portion of third component 206 formed between angled walls 262, 266. The plurality of coupling tabs 272 are configured to contact coupling protrusions 260 of second component 204 to facilitate the releasable coupling between third component 206 and second component 204. With reference to FIGS. 2A, 2B, 4A, 4C, and 5A-5C, each of the plurality of coupling tabs 272 of third component 206 and the plurality of coupling protrusions 260 of second component 204 include holes formed therethrough. In exemplary embodiments, a suitable mechanical fastening device, for example screws, pins, rivets, etc., may be displaced through the holes formed through both the plurality of coupling tabs 272 and coupling protrusions 260 to releasably couple second component 204 and third component 206 when forming housing 200. Although discussed herein as utilizing a mechanical fastening device, it is understood that any suitable coupling component and/or technique can be used to releasably couple second component 204 and third component 206 via coupling protrusions 260 and the plurality of coupling tabs 272, respectively.

FIGS. 6A and 6B show multiple views of housing 200 and centrifuge force microscope system 300 included therein. More specifically, FIG. 6A shows a partially exploded perspective view of housing 200 and centrifuge force microscope system 300, while FIG. 6B shows a front cross-sectional view of housing 200 and centrifuge force microscope system 300. It is understood that similarly numbered and/or named components may function in a substantially similar fashion. Redundant explanation of these components has been omitted for brevity.

As discussed herein centrifuge force microscope system 300 utilized by centrifuge 100 (see, FIG. 1) includes housing 200 to support various assemblies and/or devices included within centrifuge force microscope system 300. For example, and as shown in FIGS. 6A and 6B, centrifuge force microscope system 300 includes a light element assembly 302 positioned within illumination housing 218 of first component 202 forming housing 200. As discussed herein, illumination housing 218 is formed integral to bottom portion 208 and/or internal surface 210 of first component 202. In exemplary embodiments, light element assembly 302 includes a battery 304 disposed within battery slot 220, and a light source or element 306 (e.g., LED) disposed and/or positioned within a light element holder 222 of illumination housing 218. Additionally, light element assembly 302 also includes a diffuser 308 positioned and/or secured within diffuser mount 224 of illumination housing 218. Furthermore, a turning mirror 310 of light element assembly 302 is received and/or angularly positioned within mirror mount 226 formed on internal surface 210 of bottom portion 208, adjacent to illumination housing 218. During operation, and as discussed herein, light element assembly 302 provides a light and/or generates a light path 312 (see, FIG. 6B) through a microscope assembly of centrifuge force microscope system 300, in order to observe, inspect, and/or test a sample included therein. Furthermore, and because light element assembly 302 of centrifuge force microscope system 300 is self-contained within first component 202 of housing 200 and/or is not electrically coupled and/or connected to the microscope assembly of centrifuge force microscope system 300, first component 202 including light element assembly 302 may be removed from housing 200 without disrupting and/or adjusting other portions of centrifuge force microscope system 300.

In exemplary embodiments, centrifuge force microscope system 300 including housing 200 also includes a microscope assembly 318 formed from an imaging subassembly 320, and a sample subassembly 322. Imaging subassembly 320 of microscope assembly 318 is affixed at least one of the plurality of openings 240A, 240B formed in top portion 238 of second component 204. Additionally, and as discussed herein, imaging subassembly 320 is at least partially positioned between bottom portion 208 of first component 202 and top portion 238 of second component 204. Sample subassembly 322 is coupled to imaging subassembly 320, adjacent to bottom portion 208 of first component 202.

Imaging subassembly 320 of microscope assembly 318 includes any suitable components and/or devices configured to examine a sample within sample subassembly 322 during operation of centrifuge 100, as discussed herein. For example, and as shown in FIGS. 6A and 6B, imaging subassembly 320 includes a lens tube 324 coupled to and/or aligned with first opening 240A formed in top portion 238 of second component 204. Lens tube 324 is coupled to top portion 238 of second component 204 via a mounting plate or flange 326A that is positioned on and/or affixed to second surface 244 of top portion 238. A C-mount adapter 328 of imaging subassembly 320 is coupled to lens tube 324, opposite flange 326A and/or top portion 238 of second component 204. Additionally, imaging subassembly 320 also includes a camera 330 coupled to C-mount adapter 328. In the exemplary embodiment, C-mount adapter 328 is positioned within lens tube 324 and camera 330 within imaging subassembly 320.

Additionally, imaging subassembly 320 of microscope assembly 318 includes a distinct lens tube 332 coupled to and/or aligned with second opening 240B formed in top portion 238 of second component 204. Distinct lens tube 332 is coupled to top portion 238 of second component 204 via flange 326B that is positioned on and/or affixed to second surface 244 of top portion 238. Flange 326B secures and/or positioned distinct lens tube 332 to be aligned with and/or at least partially disposed through second opening 240B formed in second component 204. As shown in FIGS. 6A and 6B, imaging subassembly 320 also includes an objective 334 positioned within distinct lens tube 332. Objective 334 is configured to adjust the image zoom for imaging subassembly 320 when observing the sample included within sample subassembly 322 during operation. Imaging subassembly 320 further includes a lens tube coupler 336 coupled to an end of distinct lens tube 332. Lens tube coupler 336 is positioned opposite top portion 238 of second component 204 and is configured to couple a sample lens tube of sample subassembly 322 to imaging subassembly 320 during operation.

Sample subassembly 322 of microscope assembly 318 is coupled to imaging subassembly 320. More specifically, a sample lens tube 338 of sample subassembly 322 is configured to be coupled to lens tube coupler 336 of imaging subassembly 320 during operation of centrifuge force microscope system 300. In exemplary embodiments, sample lens tube 338 includes, encompasses, and/or houses a plurality distinct components relating to the sample to be tested using centrifuge force microscope system 300. For example, sample lens tube 338 of sample subassembly 322 includes a chamber mount 340 positioned adjacent to objective 334 of imaging subassembly 320, an optic spacer 342 positioned adjacent chamber mount 340, and a lens tube size adapter 344 positioned adjacent the optic spacer 342. Coupled to the lens tube size adapter 344 is a small lens tube 346 including Fresnel lens 348 disposed and/or positioned therein.

As shown in FIGS. 6A and 6B, centrifuge force microscope system 300 also includes a first turning mirror 350 and a second turning mirror 352 coupled to housing 200. More specifically, first turning mirror 350 is coupled to first angled wall 262 of third component 206 for housing 200. First turning mirror 350 is aligned with first opening 240A of the plurality of openings 240A, 240B formed through top portion 238 of second component 204. Additionally, first turning mirror 350 is aligned with at least a portion of imaging subassembly 320 for microscope assembly 318. In the exemplary embodiment, first turning mirror 350 is substantially aligned with lens tube 324, C-mount adapter 328, and/or camera 330 of imaging subassembly 320.

Second turning mirror 352 is coupled to second angled wall 266 of third component 206 for housing 200. Second turning mirror 352 is aligned with second opening 240B of the plurality of openings 240A, 240B formed through top portion 238 of second component 204. Additionally, Second turning mirror 352 is aligned with at least a portion of imaging subassembly 320 for microscope assembly 318. As shown in FIG. 6B, second turning mirror 352 is substantially aligned with distinct lens tube 332, objective 334, and/or lens tube coupler 336 of imaging subassembly 320. Additionally, second turning mirror 352 is substantially aligned with sample lens tube 338 optic space 342, small lens tube 346, and/or Fresnel lens 348 of sample subassembly 322 as well.

During operation, light element assembly 302 generates a light source within centrifuge force microscope system 300 to allow microscope assembly 318 to capture images of the sample including in sample subassembly 322. For example, and as shown in FIG. 6B, a light path 312 is generated by lighting element 306, that moves through diffuser 308, is redirected toward sample subassembly 322 and a portion of imaging subassembly 320 via turning mirror 310 mounted on mirror mount 226 of first component 202. Concurrently, camera 330 of imaging subassembly 320 utilizes turning mirrors 350, 352 positioned within third component 206 of housing 200, and objective 334 to capture images of the backlit sample found within sample subassembly 322 during operation.

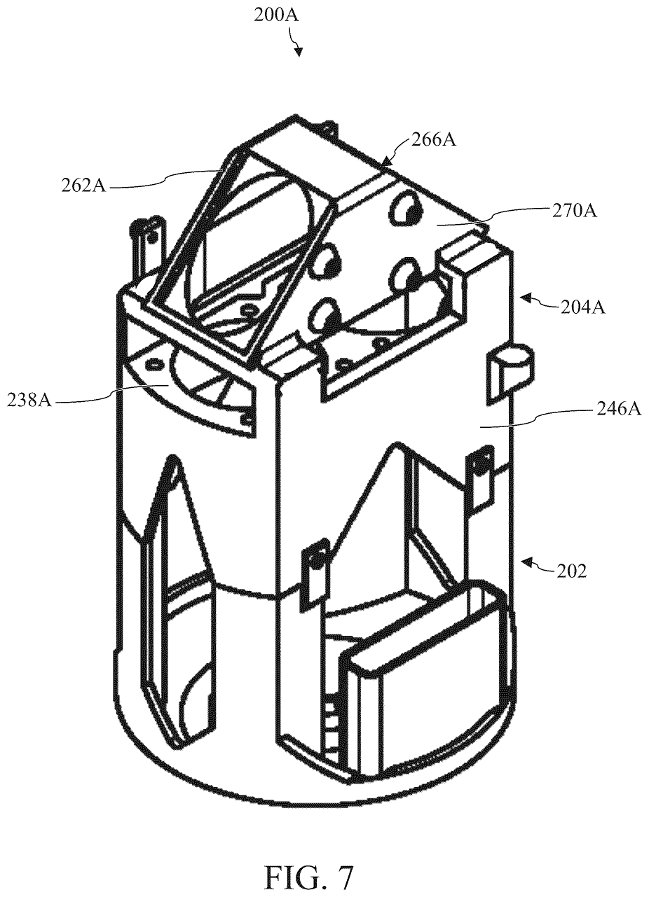

FIG. 7 shows a perspective view of housing 200A used within centrifuge force microscope system 300 and/or centrifuge 100. It is understood that similarly numbered and/or named components may function in a substantially similar fashion. Redundant explanation of these components has been omitted for brevity.

In the exemplary embodiment shown in FIG. 7, housing 200A is formed from first component 202 and second component 204A. In the non-limiting, first component 202 of housing 200A is substantially similar to first component 202 discussed herein with respect to FIGS. 2A-6B. However, second component 204A of housing 200A is substantially similar to a combination of second component 204 and third component 206 discussed herein with respect to FIGS. 2A-6B. That is, and as shown in FIG. 7, second component 204A in housing 200A is formed such that second component 204 and third component 206 of housing 200, as discussed herein, were formed integral with one another as single, unitary component (e.g., second component 204A). For example, second component 204A includes top portion 238A, and sidewalls 246A, as well as a first angled wall 262A formed above top portion 238A and opposite sidewalls 246A. In the embodiments, second component 204A also includes a second angled wall 266A formed adjacent first angled wall 262A, and above top portion 238A. Each of first angled wall 262A and second angled wall 266A are also aligned with respective openings 240A, 240B formed through top portion 238A of second component 204A. Furthermore, second component 204A also includes two barrier walls 270A formed opposite one another, and extending between first angled wall 262A and second angled wall 266A.

FIGS. 8A-8D show various views of a balancing device 400 utilized along with centrifuge force microscope system 300 including housing 200 within centrifuge 100 during operation. Specifically, FIG. 8A shows an exploded, perspective view of balancing device 400, FIG. 8B shows a side view of balancing device 400, FIG. 8C shows a top view of balancing device 400, and FIG. 8D shows a cross-sectional side view of balancing device 400.

In exemplary embodiments, balancing device 400 includes two distinct elements. More specifically, balancing device 400 includes a female, base element 402, and a male, top element 404. As shown in FIGS. 8A-8D, base element 402 includes an inner surface 406 that includes threads or a threaded pattern 408. Additionally, top element 404 includes an outer surface 410 that also includes threads and/or a threaded pattern 412 complementary to threaded pattern 408 of base element 402. During operation, base element 402 is configured to receive, engage, and/or threadedly be coupled to top element 404 via threaded patterns 408, 412. Including threaded patterns 408, 412 on base element 402 and top element 404 allows the depth in which top element 404 is inserted into base element 402 to be adjustable. This in turn facilitates the ability to change and/or adjust not only the weight of balancing device 400 by adding weighted objects, but also adjust the center of mass, and/or weight distribution balancing device 400 to more closely match centrifuge force microscope system 300 including housing 200.

In the exemplary embodiment, base element 402 and top element 404 each include notches 418, 420 formed therein. More specifically, base element 402 includes a plurality of notches 418 formed on inner surface 406 and spaced circumferentially apart from one another. Additionally, top element 404 includes a plurality of corresponding notches 420 formed on outer surface 410 and also spaced circumferentially apart from one another on top element 404. To prevent top element 404 from turning and thus changing height within base element 402 during operation of centrifuge 100, a post or pin (not shown) is inserted into at least one set of notches 418, 420 aligned between base element 402 and top element 404.

Additionally as shown in FIGS. 8A-8D, top element 404 includes a plurality of apertures 422 formed therein. More specifically, apertures 422 extend at least partially through top element 404 of balancing device 400. Plurality of apertures 422 are configured to receive weighted objects (e.g., weights, coins) to increase the weight of balancing device 400 to match that of centrifuge force microscope system 300 including housing 200 during operation.

FIG. 9 shows a perspective view of another balancing device 500 utilized along with centrifuge force microscope system 300 including housing 200 within centrifuge 100 during operation. In the exemplary embodiment shown in FIG. 9, balancing device 500 includes a single, unitary body including a base portion 502 having an upper surface 504 and a lower surface 506, and a plurality of tubes 508, 510 extending perpendicular from upper surface 504. Similar to the plurality of apertures 422 of balancing device 400 discussed herein, each of the plurality of tubes 508, 510 include openings and are configured to receive weighted objects (e.g., weights, coins) to increase the weight of balancing device 500 to match that of centrifuge force microscope system 300 including housing 200 during operation.

As shown in FIG. 9, the plurality of tubes 508, 510 include a single, central tube 508, and a plurality of perimeter tubes 510 formed adjacent to and circumferentially surrounding central tube 508. During operation, each of the plurality of tubes 508, 510 can receive a distinct number of weights to ensure that the overall weight of balancing device 500 matches centrifuge force microscope system 300, as well as to adjust the center of mass, and/or weight distribution of balancing device 500 to more closely match centrifuge force microscope system 300 including housing 200. In an exemplary embodiment, each of the plurality of tubes 508, 510 dissipates and/or ends at upper surface 504. In other exemplary embodiments, the opening of at least one of the plurality of tubes 508, 510 may extend into base portion 502 and/or closer to lower surface 506 than other tubes. For example, central tube 508, and two opposing perimeter tubes 510 may extend further into base portion 502 and/or closer to lower surface 506 of base portion 502 than the remaining perimeter tubes 510, which end and/or dissipate at upper surface 504.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” and/or “substantially” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A housing for a centrifuge force microscope system, the housing comprising:
a first component including:
a bottom portion including an internal surface,
an illumination housing formed on the internal surface,
a mirror mount formed on the internal surface, adjacent the illumination housing, and
a plurality of support pillars extending perpendicular to the internal surface; and
a second component releasably coupled to the first component, the second component including:
a top portion formed opposite the bottom portion of the first component, the top portion including a plurality of openings formed therethrough, and
at least one sidewall extending perpendicular to the top portion, the at least one sidewall configured to contact the plurality of support pillars of the first component.

2. The housing of claim 1, further comprising a third component releasably coupled to the second component, opposite the first component, the third component including:
a first angled wall aligned with a first opening of the plurality of openings formed through the top portion of the second component, the first angled wall configured to receive a first turning mirror;
a second angled wall formed adjacent the first angled wall, the second angled wall aligned with a second opening of the plurality of openings formed through the top portion of the second component,
wherein the second angled wall is configured to receive a second turning mirror; and
two barrier walls formed opposite one another, each of the two barrier walls extending between the first angled wall and the second angled wall.

3. The housing of claim 2, wherein the second component includes a plurality of coupling protrusions extending from the top portion, opposite the at least one sidewall, and
wherein the third component includes a plurality of coupling tabs extending perpendicular to the two barrier walls, the plurality of coupling tabs configured to contact the plurality of coupling protrusions of the second component and releasably couple the third component to the second component.

4. The housing of claim 1, wherein the second component further includes:
a first angled wall formed above the top portion and opposite the at least one sidewall, the first angled wall aligned with one opening of the plurality of openings formed through the top portion,
wherein the first angled wall configured to receive a turning mirror;
a second angled wall formed adjacent the first angled wall, the second angled wall aligned with a distinct opening of the plurality of openings formed through the top portion,
wherein the second angled wall is configured to receive a distinct turning mirror; and
two barrier walls formed opposite one another, each of the two barrier walls extending between the first angled wall and the second angled wall.

5. The housing of claim 1, wherein the first component further includes a plurality of alignment guides extending from the plurality of support pillars.

6. The housing of claim 5, wherein the second component further includes a plurality of recesses formed in the at least one sidewall, each of the plurality of recesses configured to receive one of the plurality of alignment guides of the first component.

7. The housing of claim 1, wherein the first component includes a first portion of a releasable coupling feature formed on at least one of the plurality of support pillars, and the second component includes a second portion of the releasable coupling feature formed on the at least one sidewall, the first portion and the second portion of the releasable coupling feature configured to releasably engage one another.

8. The housing of claim 1, wherein the plurality of support pillars of the first component and the at least one sidewall of the second component are configured to define at least one aperture providing access to an internal area formed between the first component and the second component when releasably coupled.

9. A centrifuge force microscope system, comprising:
a housing configured to be positioned within a centrifuge sample bucket, the housing including:
a first component including:
a bottom portion including an internal surface,
an illumination housing formed on the internal surface,
a mirror mount formed on the internal surface, adjacent the illumination housing, and
a plurality of support pillars extending perpendicular to the internal surface; and
a second component releasably coupled to the first component, the second component including:
a top portion formed opposite the bottom portion of the first component, the top portion including a plurality of openings formed therethrough, and
at least one sidewall extending perpendicular to the top portion, the at least one sidewall configured to contact the plurality of support pillars of the first component;
a light element assembly positioned within the illumination housing formed on the internal surface of the first component for the housing; and
a microscope assembly positioned within the housing, the microscope assembly including:
an imaging subassembly affixed to at least one of the plurality of openings formed in the top portion of the second component and at least partially positioned between the bottom portion of the first component and the top portion of the second component; and
a sample subassembly coupled to the imaging subassembly, adjacent to the bottom portion of the first component.

10. The centrifuge force microscope system of claim 9, wherein the housing further includes a third component releasably coupled to the second component, opposite the first component, the third component including:
a first angled wall aligned with a first opening of the plurality of openings formed through the top portion of the second component;
a second angled wall formed adjacent the first angled wall, the second angled wall aligned with a second opening of the plurality of openings formed through the top portion of the second component; and
two barrier walls formed opposite one another, each of the two barrier walls extending between the first angled wall and the second angled wall.

11. The centrifuge force microscope system of claim 10, wherein the second component of the housing further includes a plurality of coupling protrusions extending from the top portion, opposite the at least one sidewall, and
wherein the third component of the housing further includes a plurality of coupling tabs extending perpendicular to the two barrier walls, the plurality of coupling tabs configured to contact the plurality of coupling protrusions of the second component and releasably couple the third component to the second component.

12. The centrifuge force microscope system of claim 10, further comprising:
a first turning mirror coupled to the first angled wall of the third component, the first turning mirror aligned with the first opening of the plurality of openings and at least a portion of the imaging subassembly for the microscope assembly; and
a second turning mirror coupled to the second angled wall of the third component, the second turning mirror aligned with the second opening of the plurality of openings and at least a distinct portion of the imaging subassembly and the sample subassembly for the microscope assembly.

13. The centrifuge force microscope system of claim 9, wherein the second component of the housing further includes:
a first angled wall formed above the top portion and opposite the at least one sidewall, the first angled wall aligned with at least a portion of the imaging subassembly for the microscope assembly;
a second angled wall formed adjacent the first angled wall, the second angled wall aligned with a distinct portion of the imaging subassembly and the sample subassembly for the microscope assembly; and
two barrier walls formed opposite one another, each of the two barrier walls extending between the first angled wall and the second angled wall.

14. The centrifuge force microscope system of claim 9, wherein the first component of the housing further includes a plurality of alignment guides extending from the plurality of support pillars, and wherein the second component of the housing further includes a plurality of recesses formed in the at least one sidewall, each of the plurality of recesses configured to receive one of the plurality of alignment guides of the first component.

15. The centrifuge force microscope system of claim 9, wherein the housing further includes at least one releasable coupling feature formed on at least one of the first component or the second component, the at least one releasable coupling feature configured to releasably couple the first component to the second component.

16. The centrifuge force microscope system of claim 15, wherein the at least one releasable coupling feature further includes:
a first portion formed on at least one of the plurality of support pillars of the first component for the housing; and
a second portion formed on the at least one sidewall of the second component for the housing, the first portion and the second portion of the at least one releasable coupling feature configured to releasably engage one another.

17. The centrifuge force microscope system of claim 9, wherein the housing defines an internal area formed between the bottom portion of the first component, the plurality of support pillars of the first component, the top portion of the second component, and the at least one sidewall of the second component, at least a portion of the imaging subassembly and the sample subassembly of the microscope assembly disposed within the internal area.

18. The centrifuge force microscope system of claim 17, wherein the plurality of support pillars of the first component for the housing and the at least one sidewall of the second component for the housing define at least one aperture providing access to the internal area.

19. A centrifuge, comprising:
a spindle coupled to a rotor;
a plurality of buckets coupled to the spindle, the plurality of buckets including a sample bucket and a balancing bucket positioned opposite the sample bucket; and
a centrifuge force microscope system configured to be positioned within the sample bucket of the plurality of buckets, the centrifuge force microscope system includes:
a housing including:
a first component including:
a bottom portion including an internal surface,
an illumination housing formed on the internal surface,
a mirror mount formed on the internal surface, adjacent the illumination housing, and
a plurality of support pillars extending perpendicular to the internal surface; and
a second component releasably coupled to the first component, the second component including:
a top portion formed opposite the bottom portion of the first component, the top portion including a plurality of openings formed therethrough, and
at least one sidewall extending perpendicular to the top portion, the at least one sidewall configured to contact the plurality of support pillars of the first component;
a light element assembly positioned within the illumination housing formed on the internal surface of the first component for the housing; and
a microscope assembly positioned within the housing, the microscope assembly including:
an imaging subassembly affixed to at least one of the plurality of openings formed in the top portion of the second component and at least partially positioned between the bottom portion of the first component and the top portion of the second component; and
a sample subassembly coupled to the imaging subassembly, adjacent to the bottom portion of the first component.

20. The centrifuge of claim 19, further comprising:
a balancing device positioned within the balancing bucket, the balancing device including:
a base portion having an upper surface; and
a plurality of tubes extending perpendicular from the upper surface of the base portion, each of the plurality of tubes including an opening for receiving weighted objects,
wherein the plurality of tubes include a central tube, and a plurality of perimeter tubes formed adjacent to and circumferentially surrounding the central tube.
